(19) United States
(12) Patent Application Publication
(10) Pub. No.: US 2007/0063164 A1
(43) Pub. Date: Mar. 22, 2007

(54) Valve open and close apparatus

(75) Inventors: Katsuya Torii, Anjo-city (JP); Yasushi Kawano, Anjo-city (JP); Masamichi Akagawa, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city, Aichi-pref (JP)

(21) Appl. No.: 11/523,654

(22) Filed: Sep. 20, 2006

(30) Foreign Application Priority Data
Sep. 20, 2005 (JP) 2005-272020

(51) Int. Cl. F16K 1/22

(52) U.S. Cl. 251/308

(57) ABSTRACT

A valve open and close apparatus includes a resin housing, a resin valve, and a shaft. The resin housing has a fluid passage inside the housing. The resin valve has a through hole inside the valve and opens and closes the fluid passage. The shaft is press fitted inside the through hole such that the shaft is assembled to the valve. The valve includes a first shaft bearing portions, a second shaft bearing portions, and a press-fit portion. The first shaft bearing portion forms a first slide portion between the housing and the first shaft bearing portion. The second shaft bearing portion forms a second slide portion between the housing and the second shaft bearing portion. The press-fit portion is located at a position other than a radially inward portion of each of the first and second shaft bearing portions. The shaft is press fitted into the press-fit portion.

### CROSS REFERENCE TO RELATED APPLICATION

This application is based on and incorporates herein by reference Japanese Patent Application No. 2005-272020 filed on Sept. 20, 2005.

### BACKGROUND OF THE INVENTION

1. Field of the Invention

The present invention relates to a valve open and close apparatus, which includes a resin housing and a resin valve assembled inside the housing such that the valve opens and closes. Also, the present invention relates to a multiple integrated valve open and close apparatus, which includes multiple valve units arranged in a line in a longitudinal direction of a shaft at predetermined intervals inside a common casing. Here, each of the valve units includes the resin housing and the resin valve assembled inside the housing such that the valve opens and closes. Also, the common casing constitutes, for example, a part of an intake pipe of an internal combustion engine.

2. Description of Related Art

Recently, in order to reduce weight and cost of an intake air control apparatus for an internal combustion engine, which includes a multiple integrated intake air control valve, more housings have been likely to be made of metallic materials and more intake air control valves have been likely to be made of resin materials. Also, for example, it is disclosed an intake air control apparatus for an internal combustion engine, which includes multiple valve units arranged in a line in a longitudinal direction of a shaft at predetermined intervals inside a common casing (see, for example, Japanese Unexamined Patent Publication No. 2003-509634 P.1 to 9, FIGS. 1 to 6 corresponding to U.S. Pat. No. 6,979,130). Here, each of the valve units includes a resin housing, which has an elastic structure, and a resin intake air control valve assembled inside the housing such that the valve opens and closes. Also, the common casing (block) constitutes a part of an intake pipe (e.g., intake manifold) of an internal combustion engine.

Also, when it comes to the intake air control apparatus for the internal combustion engine, which includes the multiple integrated intake air control valves, it is preferable to collectively control opening degrees of the multiple integrated intake air control valves by use of a single valve drive apparatus. Specifically, the each intake air control valve of the multiple valve units is provided with a valve engaging portion, which is engaged with an outer periphery of a shaft engaging portion of a single rectangular steel bar driven by the valve drive apparatus. Also, a shaft through hole is preferably formed such that the shaft through hole extends through each valve engaging portion of each intake air control valve. Also, it is preferable that a hole shape of the shaft through hole of each intake air control valve is formed to be commensurate with an outer shape of the rectangular steel shaft. As a result, a relative rotational displacement (movement) in a rotation direction of the rectangular steel shaft relative to each intake air control valve is limited when the single rectangular steel shaft have been press fitted and fixed to the shaft through hole of each intake air control valve of the multiple valve units.

As shown in FIG. 5, a resin housing 101 as described above includes an intake air passage (fluid passage) 102 inside the housing 101. Also, a resin intake air control valve 103 includes a tubular valve pivot 105 that has a shaft through hole 104 inside the valve pivot 105. The valve pivot 105 extends in a longitudinal direction and is formed integrally with the intake air control valve 103 in a rotation center axis of the intake air control valve 103. Shaft bearing portions 112 are provided at longitudinal opposite ends of the valve pivot 105 to constitute a slide portion formed between bearing holes 111 of the housing 101 and the shaft bearing portions 112. At a radially inward portion of the valve pivot 105, the valve pivot 105 includes a press fit portion 113 that covers an entire range of the valve pivot 105, the entire range including the shaft bearing portions 112. Here, a single rectangular steel shaft 107 is press fitted and fixed to the press fit portion 113.

However, it has been difficult to attain a high degree of accuracy in shaping the intake air control valve 103 when the intake air control valve 103 is resinified. When a hole shape of the shaft through hole 104 formed inside the valve pivot 105 is formed into a polygonal hole shape (e.g., a cross section of the hole of the pivot has a rectangular hole shape) to be commensurate with an outer shape of the rectangular steel shaft 107, a radial thickness of the valve pivot 105 may be circumferentially unequally formed. Here, the radial thickness is a thickness of a cross section, which is perpendicular to a longitudinal direction of the valve pivot 105. Thus, a degree of accuracy of an outer diameter size may be degraded. Also, the rectangular steel shaft 107 is press fitted inside the shaft through hole 104. Thus, the shaft bearing portions 112 of the valve pivot 105 may be deformed (e.g., a diameter of the shaft bearing portion 112 may be enlarged).

Here, when the shaft bearing portion 112 of the valve pivot 105 is deformed (specially when the diameter of the shaft bearing portion 112 is enlarged), a contact pressure of an outer peripheral surface of the shaft bearing portion 112 relative to an inner peripheral surface of the bearing hole 111 of the housing 101 is increased. Thus, the slide characteristic (friction characteristic) of the slide portion between the inner peripheral surface of the bearing hole 111 and the outer peripheral surface of the shaft bearing portion 112 is degraded. Thus, slide resistance and friction torque of the valve pivot 105 toward the housing 101 are increased such that the intake air control valve 103 may not work properly. In order to limit the above disadvantages, the valve drive apparatus, specifically a motor actuator, is necessarily upsized.

Also, an intake pulse (pressure pulse) is generated in an intake pipe for an engine when the intake air valve is opened or closed. When the intake pulse reaches the intake air control valve 103, a minute relative displacement (movement) is generated at the slide portion formed between the inner peripheral surface of the bearing hole 111 and the outer peripheral surface of the shaft bearing portion 112. At this time, a fretting wear may be generated at the slide portion due to stress concentration. Also, resin wear particles, which are generated by a partial wear to the slide portion, may be accumulated to form a partial protrusion. Thus, the protrusion may provide biased contact and therefore, the wear of the slide portion may be further facilitated. Also, when the generated resin wear particles include glass fibers, the glass fibers may be introduced into cylinders of the internal combustion engine, and slide portions of the internal combustion engine may be disadvantageously worn.

### SUMMARY OF THE INVENTION

The present invention is made in view of the above disadvantages. Thus, it is an objective of the present invention to address at least one of the above disadvantages.

To achieve the objective of the present invention, there is provided a valve open and close apparatus, which includes a resin housing, a resin valve, and a shaft. The resin housing has a fluid passage inside the housing. The resin valve has a through hole inside the valve and opens and closes the fluid passage. The shaft is press fitted inside the through hole such that the shaft is assembled to the valve. The valve includes a first shaft bearing portions, a second shaft bearing portions, and a press-fit portion. The first shaft bearing portion forms a first slide portion between the housing and the first shaft bearing portion. The second shaft bearing portion forms a second slide portion between the housing and the second shaft bearing portion. The press-fit portion is located at a position other than a radially inward portion of each of the first and second shaft bearing portions. The shaft is press fitted into the press-fit portion.

### BRIEF DESCRIPTION OF THE DRAWINGS

The invention, together with additional objectives, features and advantages thereof, will be best understood from the following description, the appended claims and the accompanying drawings in which:

FIG. 1A is a front view of a valve pivot formed integrally with an intake air control valve according to a preferred embodiment of the present invention;

FIG. 1B is a sectional view of a valve unit according to the preferred embodiment;

FIG. 1C is a schematic view taken along line IC-IC in FIG. 1B;

FIG. 2 is a perspective view of an intake air flow control apparatus for an internal combustion engine according to the preferred embodiment;

FIG. 3 is an exploded view of the intake air flow control apparatus for the internal combustion engine according to the preferred embodiment;

FIG. 4 is a sectional view of the valve unit according to the preferred embodiment;

FIG. 5A is a front view of a valve pivot formed integrally with an intake air control valve according to a conventional art;

FIG. 5B is a sectional view of a valve unit according to the conventional art; and

FIG. 5C is a schematic view taken along line VC-VC in FIG. 5B.

### DETAILED DESCRIPTION OF PREFERRED EMBODIMENTS

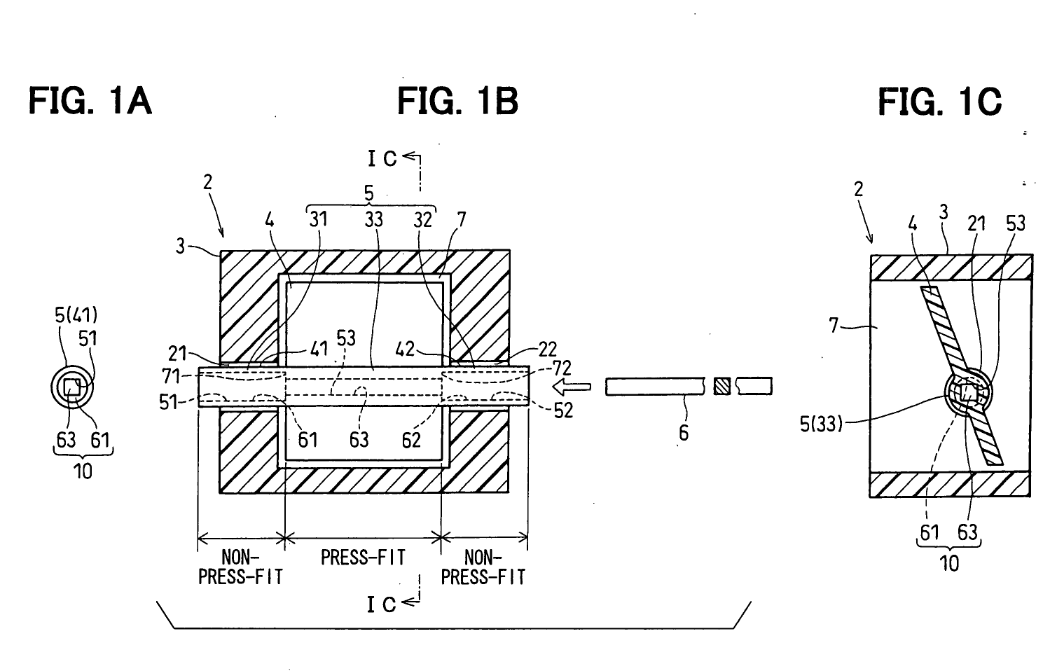

A preferred embodiment of the present invention will be described with reference to FIGS. 1A to 4.

An intake air control apparatus for an internal combustion engine of the present embodiment is an intake flow generating apparatus (a vortex flow generating apparatus), which can generate intake air vortex flow in a longitudinal direction (tumble flow) for facilitating a combustion of air-fuel mixture in each cylinder of a multi-cylinder internal combustion engine mounted on a vehicle. The multi-cylinder internal combustion engine includes, for example, a four-cylinder gasoline engine, which will be indicated as an engine hereinafter. The engine obtains power based on a thermal energy generated by burning the mixture of intake air and the fuel in a combustion chamber. The engine includes a cylinder head (not shown) and a cylinder block (not shown). The cylinder head is airtightly connected with a downstream end of an intake air pipe. The air-fuel mixture is introduced to the combustion chamber, which is formed by the cylinder block, through an intake port, which is provided to the cylinder head and is formed into a three dimensional intake air passage shape.

Here, a spark plug (not shown) is provided to the combustion chamber of each cylinder such that an end portion of the spark plug is exposed inside the combustion chamber. Also, the cylinder head includes injectors (not shown), each of which injects fuel into the intake port at proper timing. Each of multiple intake ports formed on one side of the cylinder head is opened and closed by a corresponding poppet intake valve. Also, each of multiple exhaust ports formed on another side of the cylinder head is opened and closed by a corresponding poppet exhaust valve.

The intake air pipe includes an air cleaner, air cleaner case, a throttle body, a surge tank and an intake manifold. The air cleaner (a filter element) filters the intake air. The air cleaner case houses and supports the air cleaner. The throttle body is located downstream of the air cleaner case in an intake air flow direction. The surge tank is located downstream of the throttle body. The intake manifold is located downstream of the surge tank. The intake manifold serves as a manifold for the intake air and distributes the intake air, which flows into the intake manifold, to the intake port provided to the cylinder head of the engine. The intake manifold is resinified for reducing a weight and a cost, and is integrally formed using the resin material (e.g., a glass-fiber reinforced thermoplastic resin).

Then, the intake air flow generating apparatus is provided integrally with the intake air pipe, which forms the intake air passage that communicates with the cylinder (combustion chamber) of the engine. The intake air flow generating apparatus includes a casing 1, multiple resin housings 3, multiple resin valves 4, valve pivots 5, and a single valve drive apparatus. The casing 1 forms a part of the intake air pipe of the engine and is formed into a rectangular parallelepiped shape. The multiple resin housings 3 are supported and fixed inside the casing 1 and includes the first to fourth resin housings. Each of the multiple resin valves 4 is provided to and rotatably received in a corresponding one of the housings 3 such that the each valve 4 is opened and closed. The multiple resin valves 4 are multiple integrated intake air flow control valves (hereinafter indicated as intake air flow control valves) and include the first to fourth resin valves. Each of the valve pivots 5 is formed integrally (integrally resin molded) with a corresponding one of the intake air flow control valves 4 at a vicinity of a rotation center axis of the corresponding control valve 4. The valve drive apparatus can collectively change valve opening degrees (rotation angles) of the multiple intake air flow control valves 4. In other words, the intake air flow generating apparatus structures an intake air flow control valve module (multiple integrated valve open and close apparatus), which includes multiple valve units 2 arranged in a line inside a common casing 1 at predetermined intervals in a longitudinal direction of a valve shaft (rectangular steel shaft) 6. Here, each of the valve units 2 includes the resin housing and the resin valve, which is assembled inside the housing such that the valve opens and closes.

A valve drive apparatus for opening and closing operations of the multiple intake air flow control valves 4 of the present embodiment includes an electric actuator with a power unit. The power unit includes an electric motor, which is driven using electricity, and a power transmission mechanism (a gear reducer in the present embodiment), which transmits a rotational movement of a motor shaft (output shaft) of the electric motor to the single valve shaft 6. A direct current (DC) motor (e.g., a brushless DC motor, a brush DC motor) serves as the electric motor. An alternating current (AC) motor (e.g., a three-phase induction motor) may serve as the electric motor. Also, the gear reducer mechanism reduces a rotational speed of the motor shaft of the electric motor by a predetermined reduction ratio. The gear reducer mechanism constitutes the power transmission mechanism that transmits a motor output shaft torque (drive power) of the electric motor to the valve shaft 6. The valve drive apparatus, specially the electric motor, is structured for being electrically controlled by an engine control unit (ECU).

The casing 1 of the present embodiment is a block (a vehicle component, engine component, resin intake manifold), which forms a part of or an entire of the intake manifold. The casing 1 is integrally formed into a rectangular parallelopiped shape with a resin material (e.g., a thermoplastic resin). The casing 1 includes multiple fit bores (valve unit receiving portions) 11 and multiple partition walls 12. Each of the multiple fit bores 11 receives and supports the housing 3 of a corresponding one of the multiple valve units (the first to fourth valve units) 2, and the multiple fit bores 11 are the first to fourth fit bores. Each of the multiple partition walls 12 provides an airtight partition between adjacent fit bores 11. For example, the adjacent fit bores are a pair of the first and second fit bores, a pair of the second and third fit bores, and a pair of the third and fourth fit bores.

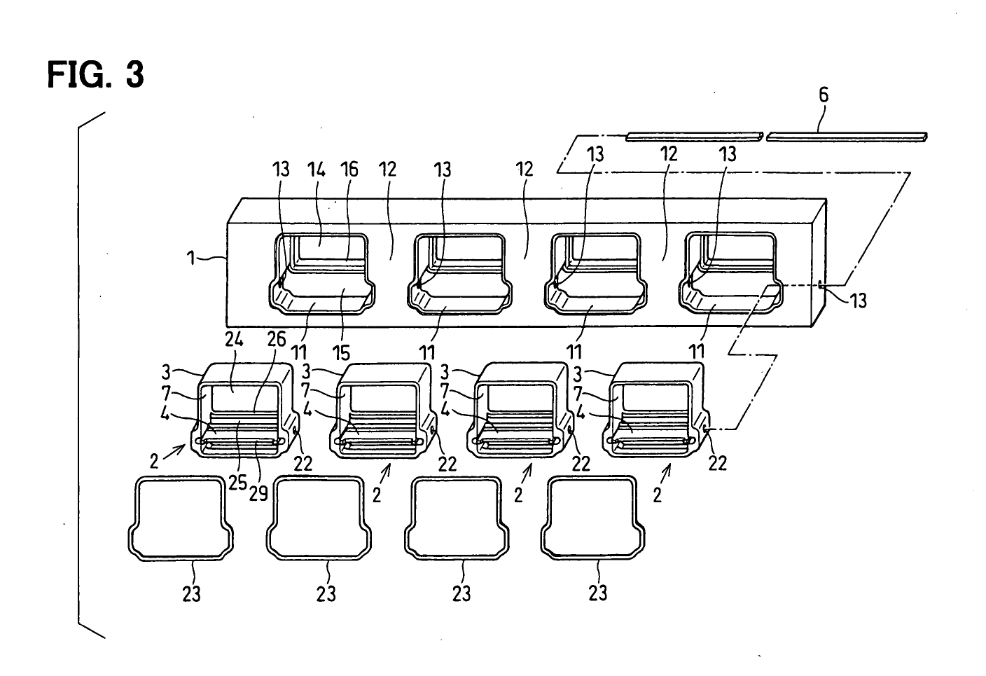

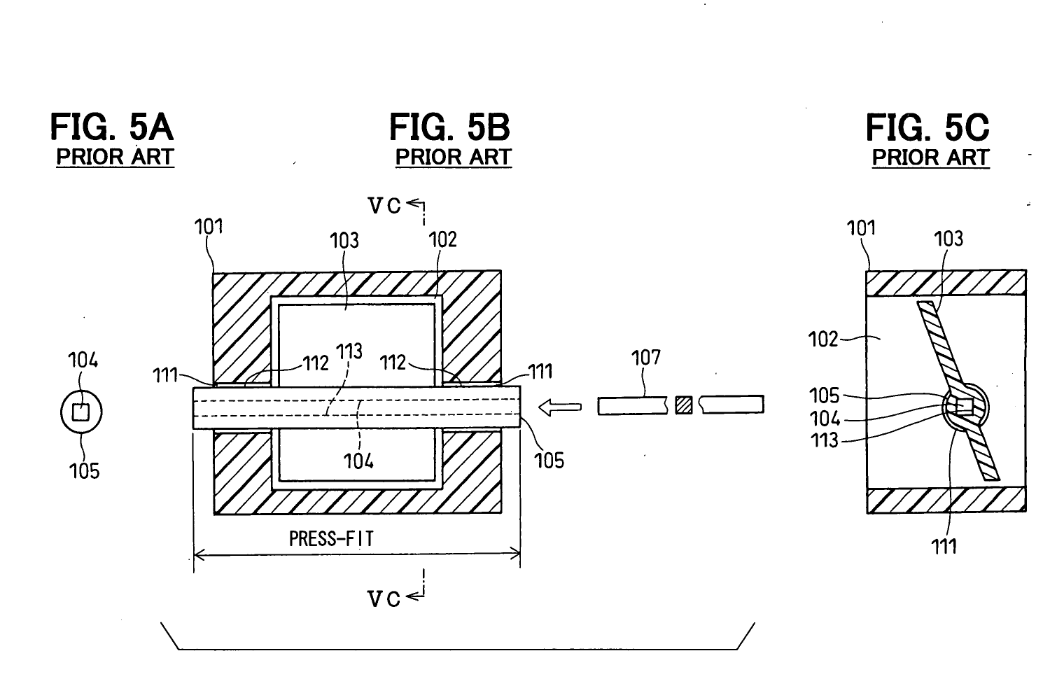

The casing 1 includes shaft insert holes 13 that extend in a direction from one side wall portion of the casing 1 (right side in FIG. 3) to another side wall portion (left side in FIG. 3) such that the shaft insert holes 13 communicate with (extend through) all of the fit bores 11 and all of the partition walls 12. In other words, each of the shaft insert holes 13 is arranged in the casing 1 to extend in a direction orthogonal to an axial direction of an average flow of the intake air, which flows through the air passage. The casing 1 integrally includes separation wall portions 16, each of which are formed on an end face of an intake port side of the casing 1. Therefore, a portion of the casing 1 that corresponds to a downstream side (the intake port side) of each air passage formed in the housing 3 is sectioned into a first air gate 14 and a second air gate 15 by a corresponding one of the separation wall portions 16. Here, the separation wall portion 16 is formed into a polygonal tubular shape. The first air gate 14 is located on an upper side, and the second air gate 15 is located on the lower side. It is noted that the first and second air gates 14, 15 and the separation wall portions 16 may not be provided.

Here, the number of the multiple valve units 2 corresponds to the number of cylinders of the engine. The first to fourth valve units are arranged in this order in the casing 1 from a top to the end of the valve shaft 6 in an inserting direction of the valve shaft 6. The housing 3 of each valve unit 2 includes an air passage (fluid passage) 7, which has a cross section of a rectangular shape. The intake air flows through the air passage. Also, each of the multiple intake air flow control valves 4 includes a shaft through hole (through hole) 10, which extends straight in the direction orthogonal to the axial direction of the average flow of the intake air, which flows through the air passage 7.

The housing 3 is formed into an oblong (or rectangular) tubular shape, and includes the air passage 7 inside the housing 3. These housings 3 are all made of the resin material (i.e., the housings 3 are resinified), and the housings 3 are integrally formed into predetermined shapes by use of the resin material (e.g., a glass-fiber reinforced thermoplastic resin). Each housing 3 includes the air passage 7, which is defined by four sides (two pairs of opposites sides). A cross section of the air passage 7 has a generally rectangular shape. The air passage 7 of each housing 3 is communicated with a corresponding one of the cylinders (combustion chambers) of the engine through a corresponding one of multiple intake ports. Here, each of the multiple intake ports is independently (correspondingly) connected to a corresponding one of multiple valve units 2.

The housing 3 includes first and second bearing holes 21, 22, each of which has a cross section of a circular shape, at opposite sides of the housing 3 in a direction orthogonal to the axial direction of the average flow of the intake air, which flows through each of the air passage 7. Also, each of the annular gaskets (a rubber elastic body, a floating rubber) 23 is engaged with an upstream end portion of a corresponding one of the housings 3 in order to airtightly seal a connection between a downstream end portion of the intake air pipe and the upstream end portion of the corresponding housing 3. Here, the intake air pipe includes an intake air duct, throttle body, the surge tank, or the intake pipe, and the annular gaskets 23 have sealing function. Each of the housings 3 integrally includes a separation wall portion 26, which is formed on an end face of an intake port side of the housing 3. Therefore, a downstream side (the intake port side) of the air passage 7 is sectioned into a first air gate 24 and a second air gate 25 by the separation wall portions 26. Here, the separation wall portion 26 is formed into a polygonal tubular shape. The first air gate 24 is located on an upper side to communicate with the first air gate 14 of the casing 1, and the second air gate 25 is located on the lower side to communicate with the second air gate 15 of the casing 1. It is noted that the first and second air gates 24, 25 and the separation wall portion 26 may not be provided.

Each of the intake air flow control valves 4 is a plate body, which has one of a square shape, a rectangular shape, and a circular shape. Here, the plate body includes a through hole (shaft through hole 10), which extends through the plate body in the longitudinal direction of the valve shaft 6. The intake air flow control valve 4 is all resinified and is integrally formed into a predetermined shape by use of the resin material (e.g., a glass-fiber reinforced thermoplastic resin). The intake air flow control valve 4 is a butterfly valve, which rotates about a rotation center axis that extends in a direction, which is orthogonal to a longitudinal direction of the housing 3. Here, the longitudinal direction of the housing 3 is the axis direction of the average flow of the intake air, which flows through the air passage 7.

Each of the multiple intake air flow control valves 4 opens and closes each air passage 7 of a corresponding one of the multiple housings 3 when the rotation angle (valve opening degree) is changed such that the intake air flow control valve 4 is rotated from a totally open position to a totally closed position. Here, when the intake air flow control valve 4 is located at the totally open position, a flow rate of the intake air, which flows through the air passage 7 of each housing 3, becomes maximum. Also, when the intake air flow control valve 4 is located at the totally closed position, the flow rate of the intake air, which flows through the air passage 7 of each housing 3, becomes minimum. Here, the intake air flow control valve 4 is spring biased by a coil spring (not shown) toward the totally open position. The rotational axis of the intake air flow control valve 4 is decentered and is located at a position lower than a center position of each housing 3 in a vertical direction (a height direction) in drawings. Thus, the intake air flow control valve 4 is a cantilever valve.

The intake air flow control valve 4 is a generally rectangular shape, which is defined by four sides that include two pairs of opposite sides. The intake air flow control valve 4 includes horizontal side faces (left and right side faces, both side faces), each of which is located on a left or right side in FIG. 1B, and vertical end faces (up and down end faces, both end faces), each of which is located on an up or down side in FIG. 1B. The horizontal side faces are longer than the vertical end faces. Alternatively, the vertical end faces may be shorter depending on a shape of the apparatus (casing, housing).

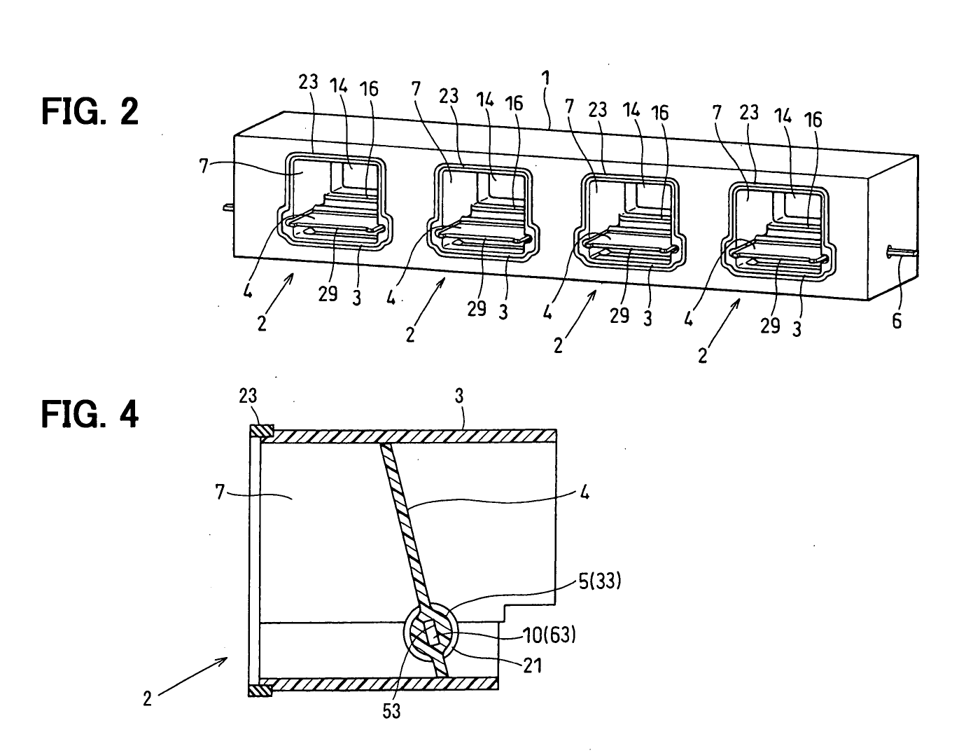

Each of the intake air flow control valves 4 is received in each air passage 7 of a corresponding one of the housings 3 such that each intake air flow control valve 4 opens and closes the air passage 7 (i.e., each intake air flow control valve 4 rotates). As shown in FIG. 2, the intake air flow control valve 4 may includes an opening portion (slit) 29, which is formed by cutting a center portion of an upper end face of the intake air flow control valve 4 (i.e., an upper portion of the air passage 7). Thus, a predetermined intake air flow can be formed between the housing 3 and the intake air flow control valve 4. However, the opening portion 29 may not be provided. Another opening portion (slit) may be formed by cutting a lower end face or a part of the horizontal side faces of the intake air flow control valve 4 so that the another opening portion forms a predetermined intake air flow between the housing 3 and the intake air flow control valve 4.

The intake air flow control valve 4 is structured as an valve-pivot-integrated intake air flow control valve, which is integrated with the valve pivot 5. Here, the valve pivot 5, which has a tubular shape, extends in the longitudinal direction of the valve shaft 6, and the valve pivot 5 is engaged with an outer periphery of the valve shaft 6.

Each valve pivot 5 of the intake air flow control valve 4 includes the shaft through hole 10 inside the valve pivot 5 such that the valve shaft 6 extends through the shaft through hole 10 in the longitudinal direction. At longitudinal ends of each valve pivot 5, each valve pivot 5 includes first and second cylindrical portions 31, 32, which are to be engaged inside the first and second bearing holes 21, 22 of a corresponding one of the housings 3. Also, at a longitudinal center portion of the valve pivot 5, in other words between the first and second cylindrical portions 31, 32, the valve pivot 5 includes a cylindrical valve support portion 33. Here, the cylindrical valve support portion 33 is received in the air passage 7 of the corresponding housing 3 along with the intake air flow control valve 4 and opens and closes the air passage 7. The intake air flow control valve 4 is integrally formed such that the intake air flow control valve 4 radially outwardly projects from an outer peripheral surface of the valve support portion 33 of the valve pivot 5.

An end (left end in FIG. 1B) of the first cylindrical portion 31 projects further than a side face (left side face) of the intake air flow control valve 4 toward a longitudinal end (left end in FIG. 1B) of the valve pivot 5. An outer peripheral portion of the first cylindrical portion 31 (radially outward surface of the first cylindrical portion 31) serves as a first shaft bearing portion (first sliding surface) 41, which constitutes a first slide portion formed between an inner peripheral surface of the first bearing hole 21 of the housing 3 and the first shaft bearing portion 41. Also, an end (right end in FIG. 1B) of the second cylindrical portion 32 projects further than another side face (right side face) of the intake air flow control valve 4 toward another longitudinal end (right end in FIG. 1B) of the valve pivot 5. An outer peripheral portion of the second cylindrical portion 32 (radially outward surface of the second cylindrical portion 32) serves as a second shaft bearing portion (second sliding surface) 42, which constitutes a second slide portion formed between an inner peripheral surface of the second bearing hole 22 of the housing 3 and the second shaft bearing portion 42.

There is formed a tubular clearance between the outer peripheral surface of the first shaft bearing portion 41 of the valve pivot 5 and the inner peripheral surface of the first bearing hole 21 such that the valve pivot 5 is smoothly rotated inside the first bearing hole 21. Also, there is formed a tubular clearance between the outer peripheral surface of the second shaft bearing portion 42 of the valve pivot 5 and the inner peripheral surface of the second shaft bearing hole 22 such that the valve pivot 5 is smoothly rotated inside the second bearing hole 22. Then, each of the first and second shaft beading portions 41, 42 is formed to have a cross section of an annular shape similarly to the first and second cylindrical portions 31, 32. Here, the cross section is perpendicular to the rotation center axis of the valve pivot 5. In other words, each of the first and second shaft bearing portions 41, 42 has a cylindrical shape that extends in the longitudinal direction of the valve shaft 6.

There are formed first and second non-press-fit portions 51, 52 at inner peripheral portions at the longitudinal ends (first and second cylindrical portions 31, 32) of the valve pivot 5. In other words, the first and second non-press-fit portions 51, 52 are formed at radially inward portions of the first and second shaft bearing portions 41, 42 of the valve pivot 5. Here, each of the first and second non-press-fit portions 51, 52 constitutes a tubular clearance formed between the outer peripheral surface of the valve shaft 6 and a corresponding one of the first and second non-press-fit portions 51, 52. A press fit portion 53 is formed at a position other than a radially inward portion of each of the first and second shaft bearing portions 41, 42. In other words, the press fit portion 53 is formed at an inner peripheral portion of a middle portion (valve support portion 33) of the valve pivot 5. Here, the valve shaft 6 is press fitted and fixed to (engaged with) the press fit portion 53. Then, the first and second non-press-fit portions 51, 52 include first and second circular holes (non-press-fit holes) 61, 62, respectively. Here, the first and second circular holes 61, 62 constitute a part of the shaft through hole 10. A shape of each of the first and second circular holes 61, 62 is a circular shape, and each of the first and second circular holes 61, 62 has an inner diameter larger than a outer diameter (e.g., a diagonal length) of the valve shaft 6. An outer opening end (right side opening end in FIG. 1B) of the second circular hole 62 may be chambered to have a tapered surface such that the valve shaft 6 is more easily inserted into the valve pivot 5. Here, the outer opening end is located on a side, from which the valve shaft 6 is inserted into the valve pivot 5. The press-fit portion 53 is provided to an inner peripheral portion of the valve pivot 5 at a position other than the first and second shaft bearing portions 41, 42 in the longitudinal direction. The press-fit portion 53 includes a polygonal hole (press-fit hole) 63, which constitutes a part of the shaft through hole 10.

The polygonal hole 63 has a polygonal hole shape (e.g., a square hole shape), and has an inner diameter generally equal to or smaller than the outer diameter (e.g., diagonal length) of the valve shaft 6. Thus, the polygonal hole 63 is formed in a size such that the inner peripheral surface of the polygonal hole 63 has a press-fit size relation with the outer peripheral surface of the valve shaft 6 (i.e. the inner peripheral surface of the polygonal hole 63 is press fitted with the outer peripheral surface of the valve shaft 6). A first annular step portion (first step surface) 71 is formed between a right end portion of the first circular hole 61 and a left end portion of the polygonal hole 63 as shown in FIG. 1B. Also, a second annular step portion (second step surface) 72 is formed between a left end portion of the second circular hole 62 and a right end portion of the polygonal hole 63 as shown in FIG. 1B. Thus, the shaft through hole 10, which extends through the valve pivot 5 of each of the intake air flow control valves 4 in the longitudinal direction, has an inner diameter lager at one side of the first step portion 71 than an inner diameter at another side of the first step portion 71. Here, the one side is located toward the first circular hole 61, which serves as the first non-press-fit portion, and the anther side is located toward the polygonal hole 63, which serves as the press fit portion. Also, the shaft through hole 10 has an inner diameter lager at one side of the second step portion 72 than an inner diameter at another side of the second step portion 72. Here, the one side is located toward the second circular hole 62, which serves as the second non-press-fit portion, and the anther side is located toward the polygonal hole 63, which serves as the press fit portion. In other words, the first and second cylindrical portions 31, 32 internally include the first and second circular holes 61, 62, and the valve support portion 33 internally includes the polygonal hole 63.

Here, the casing 1, the housing 3, the intake air flow control valve 4, and the valve pivot 5 are thermoplastic resin products (resin mold products). The thermoplastic resin products are manufactured (integrally molded with resin) using an injection molding method, where firstly a pellet resin material is melted with heat. In this molding method, secondly the melted resin material is injected into cavities of an injection molding die by applying a pressure. Thirdly, the melted resin material is cooled for curing (hardening). Then, the resin material is taken out of the injection molding die. In consideration of heat-resistant performance and strength, a polyamide resin (PA), an unsaturated polyester resin (UP), a polyphenylene sulfide (PPS), or a polybutylene terephthalate (PBT) may preferably serve as the thermoplastic resin used for the casing 1, housing 3, the intake air flow control valve 4, and the valve pivot 5. When glass-fiber reinforced thermoplastic resin serves as a resin material for the components, such as the casing 1, the housing 3, the intake air flow control valve 4, and the valve pivot 5, a resin composite material (e.g., PAG 30, or PAG 40) may be alternatively used to integrally form the components. Here, the resin composite material is made by mixing or adding resin reinforcement (e.g., glass fiber) into the thermoplastic resin of the polyamide resin (PA).

The valve shaft 6 of the present embodiment is a polygonal shaft (rectangular steel shaft, metal shaft), which has a cross section of a polygonal shape (e.g., square shape) and is made of, for example, a steel metallic material. Here, the cross section is perpendicular to the rotation center axis. Specifically, the valve shaft 6 includes shaft outer diameter portions, which have cross sections of the polygonal shape and are arranged at predetermined intervals in the longitudinal direction of the valve shaft 6. Each of the shaft outer diameter portions is engaged inside the shaft through hole 10 of the valve pivot 5 of each of the multiple intake air flow control valves 4. In the present embodiment, the valve shaft 6 has the identical cross sectional shapes at all positions in the longitudinal direction. In this way, the valve pivot 5 of each of the intake air flow control valves 4 can be reinforced. Also, the outer shape of the valve shaft 6 is formed into a shape generally identical to the hole shape of the polygonal hole 63 of the valve pivot 5. Thus, this limits a relative displacement (movement) in rotational direction of the valve shaft 6 relative to the valve pivot 5 of each of the intake air flow control valves 4. The valve shaft 6 is a single drive shaft, which connects all of the intake air flow control valves 4 such that the control valves 4 can work with each other. Here, the valve shaft 6 is press fitted to and inserted into the shaft through hole 10 of the valve pivot 5 of each of the intake air flow control valves 4. Also, the valve shaft 6 is press fitted into and fixed to the inner periphery of the polygonal hole 63 (press-fit portion 53), which is formed inside the valve support portion 33.

The assembly method of the intake air flow control apparatus for the internal combustion engine (intake flow generating apparatus) according to the present embodiment will be briefly described with reference to FIGS. 1A to 4.

Firstly, each of the casing 1, the housing 3, the intake air flow control valve 4, and the valve pivot 5 is manufactured by use of the injection molding method (injection molding step). In contrast, the valve shaft 6 is integrally formed by use of the metallic material.

Then, the valve units 2 are assembled to the fit bores 11 of the casing 1 (first step). Here, each of the valve units 2 includes the housing 3 and the intake air flow control valve 4, which is assembled into the air passage 7 of the housing 3 such that the intake air flow control valve 4 opens and closes. Thus, the valve units 2 are arranged in a line in the longitudinal direction of the valve shaft 6 at predetermined intervals inside the common casing 1.

After each of the valve units 2 has been assembled to the corresponding fit bore 11 as discussed above, the vertical end faces (up and down end faces in FIG. 4) of each of the intake air flow control valves 4 is brought into a mechanical (direct) contact with passage wall faces of the corresponding housing 3 (second step). In this case, the valve opening degree of each of the intake air flow control valves 4 is set at a valve opening degree that corresponds to the totally open position. Also, it is preferable that the shaft through holes 10 of all of the intake air flow control valves 4 are located in an axis, which is identical to a center axis of all of the shaft insert holes 13 of the casing 1.

Then, the valve shaft 6 is inserted into the shaft through hole 10 of each of the intake air flow control valves 4 from the shaft insert hole 13 formed at a right wall portion (right side wall in FIG. 3) of the casing 1 (third step). At this time, each of the shaft outer diameter portions, which are arranged at the predetermined intervals in the longitudinal direction of the valve shaft 6 and have the polygonal cross section shape, is loosely fitted inside the first and second circular holes 61, 62 of each of the intake air flow control valves 4 as shown in FIG. 1B. In other words, each of the shaft outer diameter portions is loosely fitted inside the first and second non-press-fit portions 51, 52 of the corresponding valve pivot 5. Here, the first and second circular holes 61, 62 are provided at the first and second cylindrical portions 31, 32, which are provided at opposite ends of the valve pivot 5 in the longitudinal direction.

Also, the valve outer diameter portion of the valve shaft 6 is press fitted inside the polygonal hole 63 of the valve support portion 33 provided at a longitudinally middle portion of the valve pivot 5 of each of the intake air flow control valves 4. In other words, the valve outer diameter portion is press fitted inside the press-fit portion 53. Therefore, the valve shaft 6 is press fitted and fixed to the press-fit portion 53 of each of the intake air flow control valves 4. Thus, the all of the intake air flow control valves 4 are integrally coupled with the outer peripheries of the shaft outer diameter portions of the valve shaft 6 such that the valve opening degrees (rotation angles) of all of the multiple intake air flow control valves 4 can be collectively changed by the single valve shaft 6. In the above process, the intake air flow control apparatus for the internal combustion engine (intake flow generating apparatus), the intake air flow control apparatus having the casing 1, the valve units 2 and the valve shaft 6, is manufactured.

Effects (advantages) of the intake air flow control apparatus for the internal combustion engine (intake flow generating apparatus) according to the present embodiment will be briefly described with reference to FIGS. 1A to 4.

In a case where the tumble flow needs to be generated, each of the intake air flow control valves 4 is closed (is located at the totally closed position) such that the intake air, which is filtered through the air cleaner, is supplied to each intake port through the opening portion 29 of each intake air flow control valve 4 and through a vicinity of a passage wall face of the first air gate 14 located at the upper part. Then, the intake air is introduced to the combustion chamber of each cylinder of the engine passing by the intake valve. Most of the intake air introduced to the combustion chamber passes through the opening portion 29 of the intake air flow control valve 4. Thus, the air flow of the intake air introduced to the combustion chamber becomes the vortex flow in the vertical direction (the tumble flow).

In other words, the vortex flow in the vertical direction (the tumble flow) can be easily generated because the air-fuel mixture can be introduced to the combustion chamber through the opening portion 29 of the intake air flow control valve 4, the first air gate 14 (the upper portion of the intake air passage inside the intake manifold) and the upper portion of the intake port, when the intake air flow control valve 4 is located in the totally closed position. Therefore, the tumble flow, which facilitates burning the air-fuel mixture in the combustion chamber of each cylinder of the engine, can be actively generated. Thus, the mixture can be burned at a certain air-fuel ratio (a lean burn state), where the mixture otherwise cannot be easily burned, so that the fuel economy can be improved without degrading engine performance.

In the present invention, the valve pivot 5 is integrally formed with the corresponding intake air flow control valve 4. Thus, there is no need for assembling the valve pivot 5 to the control valve 4 and also the number of the compounds can be reduced. As a result, cost can be reduced.

As described above, in the intake air flow control apparatus for the internal combustion engine (intake air flow generating apparatus) of the present embodiment, the valve units 2 are arranged in the line in the longitudinal direction of the valve shaft 6 inside the common casing 1 at the predetermined intervals. Here, each of the valve units 2 includes the resin housing 3 and the resin intake air flow control valve 4, which is assembled inside the housing 3 such that the valve opens and closes. The cylindrical valve pivot 5, which internally includes the shaft through hole 10, is formed integrally with each of the intake air flow control valves 4 at the vicinity of the rotation center axis of the intake air flow control valve 4. Also, the first and second shaft bearing portions 41, 42 are formed at the outer peripheral portions of the longitudinal ends of the valve pivot 5 (the first and second cylindrical portions 31, 32). Here, the first and second shaft bearing portions 41, 42 constitute the first and second slide portions, each of which is formed between the inner peripheral surface of the first (second) bearing hole 21 (22) of the housing 3 and the outer peripheral surface of the first (second) shaft bearing portion 41 (42). The first and second non-press-fit portions 51, 52 are formed at inner peripheral portions of the first and second cylindrical portions 31, 32 (i.e. at the radially inward sides of the first and second shaft bearing portions 41, 42). Here, each of the shaft outer diameter portions is loosely fitted into the fist and second non-press-fit portions 51, 52. Also, the press-fit portion 53 is formed at the position other than the radially inward portion of each of the first and second shaft bearing portions 41, 42. In other words, the press-fit portion 53 is formed at the inner peripheral portion of the valve support portion 33. Here, the shaft outer diameter portion of the valve shaft 6 is press fitted (tightly fitted) with the press-fit portion 53.

In the above structure, the shaft outer diameter portion of the valve shaft 6 is inserted into the shaft through holes 10 of the valve pivot 5 in the longitudinal direction such that the valve shaft 6 extends through the shaft through holes 10. Thus, the intake air flow control valves 4 are coupled with each other such that the valve opening degrees of all of the intake air flow control valves 4 can be collectively changed by the single valve shaft 6. In this case, the first and second non-press-fit portions 51, 52 are provided at the inner peripheral surfaces of the first and second cylindrical portions 31, 32 (i.e., at the inner peripheral surfaces of the first and second shaft bearing portions 41, 42). Thus, the press-fit engaging portion, to which the shaft outer diameter portion of the valve shaft 6 is press fitted and fixed (engaged), is not provided at the radially inward portion of the first and second shaft bearing portions 41, 42. That is, the shaft outer diameter portion is not press fitted and fixed (engaged) at the radially inward portion of the first and second shaft bearing portions 41, 42.

In other words, the tubular clearance is formed between the shaft outer diameter portion and the inner peripheral surface of the first (second) circular hole 61 (62) inside the first (second) shaft bearing portion 41 (42). Thus, the shaft outer diameter portion is loosely fitted inside the first and second circular holes 61, 62 of the first and second shaft bearing portions 41, 42. Thus, even when the shaft outer diameter portion is inserted into the first and second circular holes 61, 62, deformation and expansion (enlargement) of the outer diameter of the first and second cylindrical portions 31, 32 (the first and second shaft bearing portions 41, 42) of the valve pivot 5 of each of the intake air flow control valves 4 can be reliably limited. Thus, contact pressures of the first and second shaft bearing portions 41, 42 of each of the control valves 4 relative to the inner peripheral surface of the first and second bearing holes 21, 22 of each housing 3 can be limited from increasing. As a result, the slide performance of the first and second slide portions, which are formed between the inner peripheral surface of the first and second bearing holes 21, 22 and the first and second shaft bearing portions 41, 42, can be improved.

Because each of the first and second cylindrical portions 31, 32 (the first and second shaft bearing portions 41, 42) is formed into the cylindrical shape, the wall thickness of the first and second cylindrical portions 31, 32 (the first and second shaft bearing portions 41, 42) can be generally circumferentially equalized. Thus, a degree of accuracy of an outer diameter size of the first and second shaft bearing portions 41, 42 of each of the intake air flow control valves 4 can be improved. Thus, contact pressures of the first and second shaft bearing portions 41, 42 of each of the control valves 4 relative to the inner peripheral surface of the first and second bearing holes 21, 22 of each housing 3 is limited from increasing. As a result, the slide performance of the first and second slide portions can be improved.

Thus, slide resistance and friction torque of the first and second shaft bearing portions 41, 42 relative to the inner peripheral surface of the first and second bearing holes 21, 22 can be reduced. As a result, all of the intake air flow control valves 4 can be opened and closed using a smaller rotational power (motor output shaft torque). Thus, a valve drive apparatus (specifically a electric motor), which is driven to collectively open and close all of the intake air flow control valves 4, does not need to be upsized. As a result, the valve open and close apparatus (specifically the electric motor) can be downsized.

The outer diameter of the first and second cylindrical portions 31, 32 (the first and second shaft bearing portions 41, 42) of the valve pivot 5 of each of the intake air flow control valves 4 can be reliably limited from being deformed and enlarged. Also, the degree of accuracy of the outer diameter size of the first and second shaft bearing portions 41, 42 of each of the intake air flow control valves 4 can be improved. Thus, even when the intake air flow control apparatus for the internal combustion engine (intake flow generating apparatus) is mounted on the engine and an intake pulse is applied to the intake air flow control valves 4 during the operation of the engine, a partial wear (e.g., a fretting wear) can be limited from being generated at the first and second slide portions.

As a result, resin wear particles are limited from being generated at one of the first and second bearing holes 21, 22 of each housing 3 and the first and second shaft bearing portions 41, 42 of each intake air flow control valve 4 (i.e., the resin wear particles are limited from being generated at the first and second slide portions). Also, this can limit a disadvantageous state, where a formed protrusion provides biased contact such that the wear of the first and second slide portions is disadvantageously further facilitated when the resin wear particles, which are generated by the partial wear of the slide portion, are accumulated to form the partial protrusion. Also, this can limit another disadvantageous state, where glass fibers are introduced into cylinders of the internal combustion engine such that slide portions of the engine may be disadvantageously worn, when the generated resin wear particles includes the glass fibers. Thus, durability of the intake air flow control apparatus for the internal combustion engine (intake flow generating apparatus) having the multiple valve units 2 and durability of the engine can be improved.

Modification of the above embodiments will be described. In the above embodiments, the intake air flow control apparatus for the internal combustion engine (intake air flow generating apparatus, vortex flow generating apparatus) is structured to generate the intake air vortex flow in the vertical direction (tumble flow) for facilitating the combustion of air-fuel mixture in each cylinder of the engine. However, the intake air flow control apparatus may be alternatively structured to generate the intake air vortex flow in a horizontal direction (swirl flow) for facilitating the combustion of air-fuel mixture in each cylinder of the engine. Also, the intake air flow control apparatus for the internal combustion engine may be alternatively structured to generate a squish curl for facilitating the combustion in the engine.

In the present embodiment, the present invention is applied to the intake air flow control apparatus for the internal combustion engine for controlling the intake air supplied into the combustion chamber of each cylinder of the internal combustion engine. However, the present invention may be alternatively applied to an intake air control apparatus for the internal combustion engine for controlling a flow rate of the intake air supplied to the combustion chamber of each cylinder of the internal combustion engine. In this case, an intake air flow rate control valve, such as an idling rotational speed control valve, a throttle valve, is assembled inside the housing. Also, the present invention may be alternatively applied to an exhaust gas recirculation apparatus having an exhaust gas recirculation (ERG) control valve. Here, the ERG control valve controls a recirculation amount of exhaust gas in a system, in which a part of the exhaust gas from the engine is recirculated into the intake air passage.

Also, the present invention may be alternatively applied to an internal combustion engine variable intake air apparatus that includes a variable intake valve. The variable intake valve serves as an internal combustion engine intake air control valve that changes a length or a sectional area of the intake air passage of the intake manifold in relation to the engine rotational speed. For example, when the engine rotational speed stays in a low or medium speed range, the internal combustion engine variable intake air apparatus switches the intake passage of the intake manifold by use of the variable intake valve such that the length of the intake passage is elongated. When the engine rotational speed stays in a high speed range, the internal combustion engine variable intake air apparatus switches the intake passage of the intake manifold by use of the variable intake valve such that the length of the intake passage is shortened. In this way, the internal combustion engine variable intake air apparatus can improve the engine output shaft torque (engine torque) regardless of the engine rotational speed. Also, the fluid is not limited to gas, such as the intake air or exhaust gas. However, liquid, such as water or oil, may be used.

In the above embodiments, the valve drive apparatus for opening and closing operations of the intake air flow control valve 4 includes the electric actuator with the power unit. The power unit includes the electric motor and the power transmission mechanism (e.g., the gear reducer mechanism). However, the valve drive apparatus may be alternatively a vacuum actuator or a solenoid actuator. Here, the vacuum actuator has a solenoid vacuum valve or an electric vacuum valve. A valve biasing member, such as a spring, which biases the valve toward the opening or closing direction, is not needed. In the above embodiments, the butterfly valve, which rotates about the rotation axis of the valve pivot 5, serves as the valve to describe the embodiments. However, an alternative valve, such as a plate valve, a rotary valve, may be used.

In the above embodiments, the present invention is applied to the inline four-cylinder engine, in which the cylinders are arranged in a group. However, the present invention may be alternatively applied to an internal combustion engine, which includes a plurality of banks having a group of arranged cylinders. The above alternative internal combustion engine includes a multiple cylinder engine, such as a V-type engine, a horizontal engine, a horizontal opposed engine. Additional bearing members (e.g., ball bearings) may be alternatively set between the inner peripheral surfaces of the first and second bearing holes 21, 22 of each housing 3 and the first and second shaft bearing portions 41, 42 of each intake air flow control valves 4. Also, the valve is not limited to the multiple integrated valves. However, the valve may be alternatively a single valve as long as the single valve is integrated with the valve pivot. In the present embodiment, the press-fit portion 53 of the each valve pivot 5 has the hole shape of the polygonal shape. However, the hole shape may be alternatively a circular hole shape or a D shape.

In the present embodiment, the valve shaft 6 is integrally formed into the polygonal shape by use of the metallic material. However, the valve shaft 6 may be integrally formed by the resin material. In this case, firstly the valve shaft 6 is press fitted into the press-fit portion 53 of each valve pivot 5. Then, the outer peripheral portion of the valve shaft 6 may be assembled to the inner peripheral portion of the longitudinal middle portion (valve support portion 33) of the valve pivot 5 by use of, for example, the welding method, such as a laser welding, a vibration welding. This can rigidly fix the valve shaft 6 to the intake air flow control valve 4.

In the present embodiment, the valve shaft 6 has the polygonal cross sectional shape at all positions in the longitudinal direction, the cross sectional shape corresponding the hole shape of the press-fit portion 53. However, only shaft outer diameter portions (press-fitted portions of the valve shaft 6), which are press fitted with the press-fit portions 53 of the valve pivots 5, may alternatively have the polygonal cross sectional shape, which corresponds the hole shape of the press-fit portion 53. Also, a knurl may be performed to the outer peripheral surface of the press fitted portion of the valve shaft 6. For example, notches or recess-protrusion portions may be formed at a part of or entire of the outer peripheral surface of the press fitted portion of the valve shaft 6. Therefore, an engagement performance (coupling performance) between the press-fit portion 53 of each valve pivot 5 and the shaft outer diameter portion of the valve shaft 6 can be improved such that the relative displacement (movement) of the valve pivot 5 in rotational direction or in the longitudinal direction of the valve pivot 5 relative to the valve shaft 6 can be limited.

Additional advantages and modifications will readily occur to those skilled in the art. The invention in its broader terms is therefore not limited to the specific details, representative apparatus, and illustrative examples shown and described.

What is claimed is:

1. A valve open and close apparatus, comprising:
a resin housing that has a fluid passage inside the housing;
a resin valve that has a through hole inside the valve and opens and closes the fluid passage; and
a shaft that is press fitted inside the through hole such that the shaft is assembled to the valve, wherein:
the valve includes:
a first shaft bearing portion that forms a first slide portion between the housing and the first shaft bearing portion;
a second shaft bearing portion that forms a second slide portion between the housing and the second shaft bearing portion; and
a press-fit portion that is located at a position other than a radially inward portion of each of the first and second shaft bearing portions; and
the shaft is press fitted into the press-fit portion.

2. The valve open and close apparatus according to claim 1, wherein:
the valve includes a first non-press-fit portion at the radially inward portion of the first shaft bearing portion, the first non-press-fit portion forming a clearance between the shaft and the first non-press-fit portion; and
the valve includes a second non-press-fit portion at the radially inward portion of the second shaft bearing portion, the second non-press-fit portion forming a clearance between the shaft and the second non-press-fit portion.

3. The valve open and close apparatus according to claim 2, wherein:
each of the first and second non-press-fit portions includes a corresponding one of first and second circular holes, in which the shaft is loosely fitted.

4. The valve open and close apparatus according to claim 1, wherein:
the first shaft bearing portion has a tubular shape that extends in a longitudinal direction of the shaft; and
the second shaft bearing portion has a tubular shape that extends in the longitudinal direction of the shaft.

5. The valve open and close apparatus according to claim 1, wherein:
the shaft has a cross section of a polygonal shape, the cross section being perpendicular to a longitudinal direction of the shaft.

6. The valve open and close apparatus according to claim 5, wherein:
the press-fit portion has a polygonal-shaped hole, which has a hole shape generally identical to the polygonal shape of the cross section of the shaft; and
the shaft is tightly fitted inside the polygonal-shaped hole.

7. The valve open and close apparatus according to claim 1, wherein:
the valve includes a tubular valve pivot, which has the through hole inside the valve pivot; and
the valve pivot is integrally formed with the valve.

8. The valve open and close apparatus according to claim 7, wherein:
the shaft is received inside the through hole; and
the shaft is press fitted and engaged with an inner periphery of the valve pivot.

9. The valve open and close apparatus according to claim 7, wherein:
the first shaft bearing portion is disposed at an outer peripheral portion of a first position of the valve pivot;
the second shaft bearing portion is disposed at an outer peripheral portion of a second position of the valve pivot; and
the press fit portion is disposed in an inner periphery of the valve pivot at a position other than the first and second positions in the longitudinal direction of the valve pivot.

10. The valve open and close apparatus according to claim 9, wherein:
the shaft is received in the through hole and is press fitted and fixed to the press fit portion.

11. The valve open and close apparatus according to claim 1, wherein:
the housing includes bearing holes at opposite sides of the housing in a direction generally orthogonal to an average flow direction of fluid that flows through the fluid passage; and
each of the bearing holes slidably pivotally supports a corresponding one of the first and second shaft bearing portions, the first and second shaft bearing portions being rotatable in a rotation direction.

12. The valve open and close apparatus according to claim 1, wherein:
the housing includes bearing holes at opposite sides of the housing in a direction generally orthogonal to a longitudinal direction of the fluid passage; and
each of the bearing holes slidably pivotally supports a corresponding one of the first and second shaft bearing portions.

13. The valve open and close apparatus according to claim 1, wherein:
the shaft is integrally formed using a metallic material.

14. The valve open and close apparatus according to claim 1, wherein:
the shaft is integrally formed using a resin material.
